(19) United States
(12) Patent Application Publication
(10) Pub. No.: US 2014/0140742 A1
(43) Pub. Date: May 22, 2014

(54) FIXING APPARATUS AND IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Shigeru FUJIWARA, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/067,358

(22) Filed: Oct. 30, 2013

(30) Foreign Application Priority Data
Nov. 19, 2012 (JP) 2012-253116

(51) Int. Cl. G03G 15/20

(52) U.S. Cl. CPC G03G 15/2089
USPC 399/329

(57) ABSTRACT

A fixing apparatus includes a rotating unit, a pressing unit, an urging unit configured to urge a portion of the pressing unit towards the rotating unit to form a first nip between the rotating unit and the urged portion of the pressing unit, and a supporting unit disposed upstream of a conveying direction of a sheet with respect to the urging unit to form a second nip between the rotating unit and a portion of the pressing unit.

### CROSS-REFERENCE TO RELATED APPLICATION

This application is based upon and claims the benefit of priority from Japanese Patent Application No. 2012-253116, filed Nov. 19, 2012, the entire contents of which are incorporated herein by reference.

### FIELD

Embodiments described herein relate to a fixing apparatus and an image forming apparatus having the same.

### BACKGROUND

An image forming apparatus usually has a fixing apparatus which presses a toner image onto a sheet and heats the sheet to fix the toner image onto the sheet. In one type of such a fixing apparatus, a sheet is nipped between a pressing belt and a heating roller and a nip pad presses the pressing belt towards the heat roller. When the sheet enters a pressing region of the nip pad, the sheet vibrates when impact is made by the nip pad on the sheet. The vibration is transferred to a region of the sheet at which the toner image is still being transferred and may cause blurring of the toner image.

### BRIEF DESCRIPTION OF THE DRAWINGS

FIG. 1 is a diagram schematically illustrating an MFP according to a first embodiment.

FIG. 2 is a diagram schematically illustrating a fixing apparatus according to the first embodiment.

FIG. 3 is a table illustrating an evaluation result on the occurrence of transfer blurring caused by the fixing apparatus according to the first embodiment.

FIG. 4 is a diagram schematically illustrating a fixing apparatus according to a second embodiment.

### DETAILED DESCRIPTION

In accordance with one embodiment, a fixing apparatus includes a rotating unit, a pressing unit, an urging unit configured to urge a portion of the pressing unit towards the rotating unit to form a first nip between the rotating unit and the urged portion of the pressing unit, and a supporting unit disposed upstream of a conveying direction of a sheet with respect to the urging unit to form a second nip between the rotating unit and a portion of the pressing unit. Embodiments are described below.

### First Embodiment

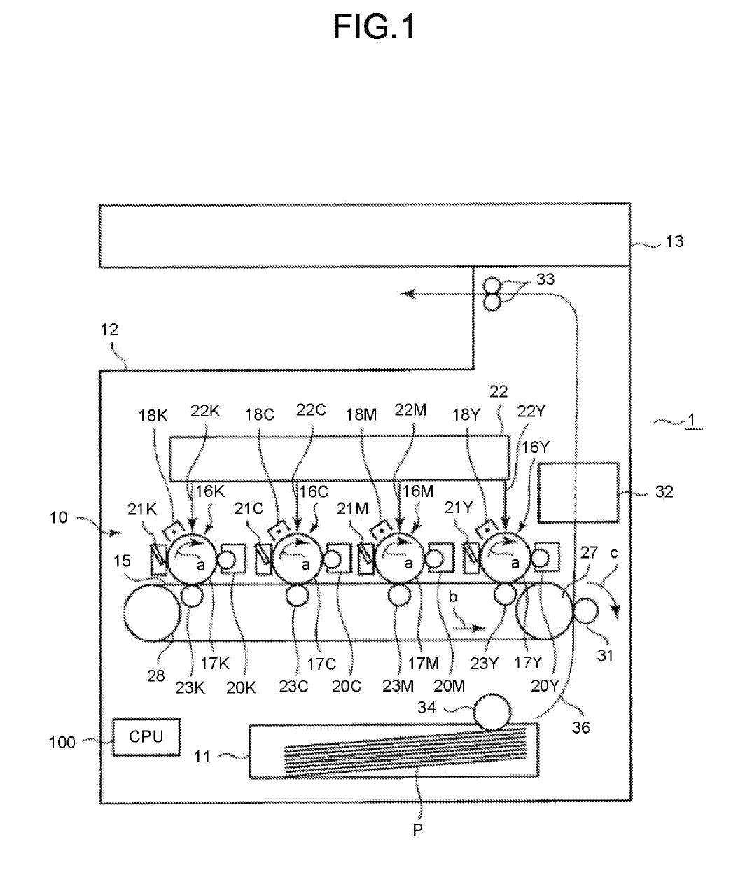

A first embodiment is described below with reference to FIG. 1-FIG. 3. FIG. 1 is a diagram schematically illustrating a MFP (Multi-function Peripheral) 1 serving as an example of an image forming apparatus according to the embodiment. The MFP 1 comprises a printer section 10, a paper feed section 11 having a pickup roller 34, a paper discharging section 12, and a scanner 13.

The printer section 10 comprises Y (yellow), M (magenta), C (cyan), and K (black) image forming stations 16Y, 16M, 16C, and 16K, which are arranged along an intermediate transfer belt 15. The image forming stations 16Y, 16M, 16C, and 16K include, respectively, chargers 18Y, 18M, 18C, and 18K, developing apparatuses 20Y, 20M, 20C, and 20K, and photoconductor cleaners 21Y, 21M, 21C, and 21K around the photoconductive drums 17Y, 17M, 17C, and 17K, each rotating in a direction indicated by an arrow a. A laser exposure apparatus 22 of the printer section 10 irradiates laser lights to form electrostatic latent images on the photoconductive drums 17Y, 17M, 17C, and 17K.

A backup roller 27 and a driven roller 28 support the intermediate transfer belt 15 to convey the intermediate transfer belt 15 in a direction indicated by an arrow b. Primary transfer rollers 23Y, 23M, 23C, and 23K inside the intermediate transfer belt 15 primarily transfer the toner images formed on the photoconductive drums 17Y, 17M, 17C, and 17K to the intermediate transfer belt 15 to form color toner images on the intermediate transfer belt 15 by overlapping Y (yellow), M (magenta), C (cyan), and K (black) toner images. The photoconductor cleaners 21Y, 21M, 21C, and 21K clean the toner left on the photoconductive drums 17Y, 17M, 17C, and 17K after the primary transfer.

A secondary transfer roller 31 disposed opposite to the backup roller 27 with respect to the intermediate transfer belt 15 is driven by the intermediate transfer belt 15 and rotates in a direction indicated by an arrow c. The secondary transfer roller 31 secondarily transfers the overlapped color toner images on the intermediate transfer belt 15 collectively to a sheet P serving as a recording medium which is fed from the paper feed section 11 along a conveyance path 36.

The intermediate transfer belt 15, the image forming stations 16Y, 16M, 16C, and 16K, the laser exposure apparatus 22, the primary transfer rollers 23Y, 23M, 23C, and 23K, and the secondary transfer roller 31 constitute an image forming section. The printer section 10 is provided with a fixing apparatus 32 and a paper discharging roller pair 33 which are disposed downstream with respect to the secondary transfer roller 31 along the conveyance path 36.

With the configuration above, the printer section 10 of the MFP 1 forms color toner images on a sheet P fed from the paper feed section 11, fixes color toner images on the sheet P, and then discharges the sheet P to the paper discharging section 12. The toner for the development of the MFP 1 may be, for example, a color non-erasable toner or a color erasable toner which is erasable when heated to a given temperature. The image forming apparatus is not limited to be the MFP 1. The image forming apparatus may be a monochrome image forming apparatus as well, and no limitation is given to the number of the developing apparatuses. The image forming apparatus may transfer a toner image directly from a photoconductor to a recording medium. Besides, the image forming apparatus may comprise a plurality of printer sections.

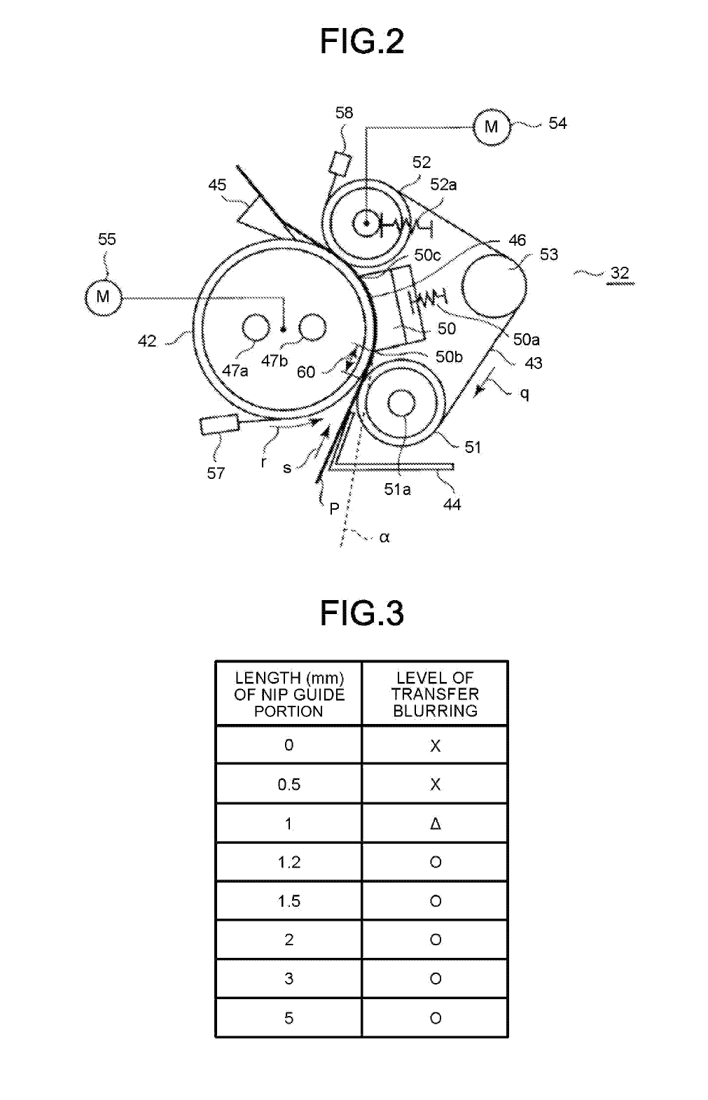

Next, the fixing apparatus 32 is described below in detail. As shown in FIG. 2, the fixing apparatus 32 comprises a heat roller 42 serving as an endless heating section and a press belt 43 serving as an endless press section disposed opposite to the outside periphery of the heat roller 42. The fixing apparatus 32 forms a nip 46 between the heat roller 42 and the press belt 43, holds and conveys a sheet P in the nip 46, and fix a toner image onto the sheet P by heating and pressurizing the toner image on the sheet. The fixing apparatus 32 comprises a guide 44 configured to guide a sheet P towards the direction of the nip 46 and a peeling claw 45 configured to peel the sheet P passing through the nip 46 from the heat roller 42.

The heat roller 42 is formed, for example, by coating a release layer on the surface of a hollow metal roller. In the hollow inside of the heat roller 42, there are two halogen lamps 47a and 47b which generating the same quantity of heat. For example, a light distribution area of one of the two halogen lamps 47a and 47b is set to be a center area in an axial direction of the heat roller 42, and a light distribution area of the other halogen lamp is set to be a side area at two sides of the center area of the heat roller 42. With the two halogen lamps 47a and 47b, the heat roller 42 is heated in the whole axial area. The heat generating section is not limited to be in a heater lamp form and can also be in an IH heater form, for example.

The press belt 43 is formed by coating the surface of a belt base material made from polyimide resin with fluororesin. In a space inside the press belt 43, a press pad 50 serving as a nip forming section is disposed. The press pad 50 presses (urges) the press belt 43 towards the heat roller 42 to form a part of the nip 46 (first nip) between the heat roller 42 and the press belt 43. The press pad 50 includes a press mechanism 50a for pressing the press pad 50 towards the heat roller 42. For example, the press surface of the press pad 50 is made from silicone rubber and formed in a curved shape corresponding to a curvature of the heat roller 42. In order to reduce the friction between the press pad 50 and the press belt 43, a sliding sheet may be arranged between the press pad 50 and the press belt 43.

In the space inside the press belt 43, a belt heat roller 51 serving as an inlet guide is disposed at a position upstream with respect to an inlet position 50b of the press pad 50 in the rotation direction indicated by an arrow q. Also, in the space inside the press belt 43, a belt pressing roller 52 serving as an outlet guide is disposed at a position downstream with respect to an outlet position 50c of the press pad 50 in the rotation direction indicated by the arrow q. Further, in the space inside the press belt 43, a tension roller 53 is disposed between the belt pressing roller 52 and the belt heat roller 51 in the rotation direction indicated by the arrow q to adjust a length of the press belt 43 between the belt heat roller 51 and the belt pressing roller 52.

The belt heat roller 51 is formed, for example, by coating a release layer on the surface of a hollow metal pipe. A halogen lamp 51a is arranged in the hollow inside of the belt heat roller 51 to heat the press belt 43. Spaced by the press belt 43, the heat roller 42 is not in contact with the belt heat roller 51. The belt heat roller 51 is located closer to the heat roller 42 than the tangent α of the heat roller 42 at the inlet position 50b of the press pad 50. The belt heat roller 51, which is located close to the heat roller 42, forms a nip guide portion (a second nip) 60, where a portion of the press belt 43 upstream with respect to the inlet position 50b of the press pad 50 is wound on the heat roller 42. The belt heat roller 51 and the heat roller 42 may be in contact the press belt 43 at a same position.

A rubber layer is arranged around a core bar of the belt pressing roller 52, and the surface of the belt pressing roller 52 is coated with fluororesin. The belt pressing roller 52 presses the press belt 43 towards the heat roller 42 to form a part of the nip 46 (a third nip) between the heat roller 42 and the press belt 43. The belt pressing roller 52 includes a roller pressing mechanism 52a for pressing (urging) the belt pressing roller 52 towards the heat roller 42.

The fixing apparatus 32 forms a long nip 46 where a part of the press belt 43 is wound on the heat roller 42 with the press pad 50 and the belt pressing roller 52. A press force caused by the belt pressing roller 52 in the nip 46 is greater than a press force caused by the press pad 50 in the nip 46. The tension roller 53 stretches the press belt 43 with a certain tension. The press belt 43 is stretched by the belt heat roller 51, the belt pressing roller 52, and the tension roller 53. By forming a long nip 46, a fixing temperature of the fixing apparatus 32 can be set to be relatively low, and the toner image formed with the color erasable toner can be fixed well without being erased.

In the fixing apparatus 32, a motor 54 drives the belt pressing roller 52 to rotate, according to which the press belt 43 rotates in a direction indicated by the arrow q, and a motor 55 drive the heat roller 42 to rotate in a direction indicated by an arrow r. The heat roller 42 and the press belt 43 can be rotated by any method. For example, one of the heat roller 42 and the press belt 43 maybe driven by a rotation of the other one.

The fixing apparatus 32 includes a roller thermistor 57 for detecting a temperature of the heat roller 42 and a belt thermistor 58 for detecting a temperature of the press belt 43. The fixing apparatus 32 determines the temperature of the heat roller 42 or the press belt 43 based on with the detection by the roller thermistor 57 and the belt thermistor 58 and controls halogen lamps 47a, 47b, and 51a to perform a fixation in a preferable condition.

When a printing operation is started, the MFP 1 forms color toner images on the intermediate transfer belt 15 with the printer section 10 and secondarily transfers all the color toner images on the intermediate transfer belt 15 collectively to a sheet P conveyed from the paper feed section 11, using the secondary transfer roller 31. The sheet P reaching the fixing apparatus 32 after the secondary transfer and having the color toner images is guided by the guide 44 and conveyed to the nip guide portion 60. At the nip guide portion 60, the sheet P is clamped by the heat roller 42 rotating along the direction indicated by an arrow r and the press belt 43 rotating along the direction indicated by the arrow q and conveyed to the inlet position 50b of the press pad 50.

The sheet P reaching the inlet position 50b of the press pad 50 enters the part of the nip 46 (first nip) formed by the heat roller 42 and the press belt 43. The sheet P is pressed with the press force caused by the press pad 50 and then pressed with the press force that is greater than the press force caused by the belt pressing roller 52 after passing through the outlet position 50c of the press pad 50, then the sheet P is discharged from the nip 46. Bypassing through the nip 46, the color toner images on the sheet P are fixed onto the sheet P by being heated and pressurized onto the sheet. The sheet P coming out from the nip 46 is peeled from the heat roller 42 by the peeling claw 45 and discharged to the paper discharging section 12 by the paper discharging roller pair 33.

When passing through the fixing apparatus 32, the sheet P conveyed in a direction indicated by an arrow s is first clamped at the nip guide portion 60. Since there is little hindrance in the conveyance of the sheet P when the sheet P is guided to the nip guide portion 60, the sheet P undergoes little impact. Then, there is an impact on the front end of the sheet P at a moment when the sheet P enters the nip 46 from the inlet position 50b of the press pad 50. However, as the sheet P is clamped in the nip guide portion 60, the impact on the front end of the sheet P is absorbed in the nip guide portion 60 and not transferred to the rear part of the sheet P, a region of the sheet P located at the position of the secondary transfer roller 31 does not vibrate. Therefore, when the sheet P enters the inlet position 50b of the press pad 50, the region of the sheet P at the position of the secondary transfer roller 31 can be prevented from vibrating even if there is an impact on the front end of the sheet P. Thus, no transfer blurring of a toner image occurs.

Moreover, by setting the press force caused by the press pad 50 smaller than the press force caused by the belt pressing roller 52, the impact on the front end of the sheet P at the inlet position 50b of the press pad 50 is weakened. During the period in which the sheet P passes through the fixing apparatus 32, the pressure applied to the sheet P is gradually increased as the sheet P sequentially passes through the nip guide portion 60, the press pad 50 of the nip 46, and the belt pressing roller 52 of the nip 46. The front end of the sheet P will not receive a severe and sharp impact at the inlet position 50b of the press pad 50 during conveyance.

The position of the belt heat roller 51 of the fixing apparatus 32 and the length of the nip guide portion 60 were changed to evaluate the occurrence of the transfer blurring in a toner image caused by an impact received during fixation. The occurrence of the transfer blurring was evaluated using the entire area of the half tone image on an A3 sized sheet of JIS standard with respect to each different length of the nip guide portion 60. FIG. 3 shows an evaluation result. In FIG. 3, ◯ represents no transfer blurring, Δ represents slight transfer blurring, and × represents severe transfer blurring. Severe transfer blurring occurred when there was no nip guide portion 60 (length=0 mm) or the length of the nip guide portion 60 is 0.5 mm, and slight transfer blurring occurred when the length of the nip guide portion 60 was 1 mm. When the length of the nip guide portion 60 was equal to or greater than 1.2 mm, then no transfer blurring occurred whether or not there was an impact on the sheet conveyed to the nip 46, and an excellent image was consequentially obtained.

According to the first embodiment, a nip guide portion 60 is formed at a position upstream with respect to the inlet position 50b of the press pad 50 of the fixing apparatus 32. When a sheet P enters the inlet position 50b of the press pad 50, the nip guide portion 60 absorbs the vibration of the sheet P even if there is an impact on the front end of the sheet P. The region of the sheet P at the position of the secondary transfer roller 31 is prevented from vibrating whether or not there is an impact on the sheet P entering the nip 46, thereby preventing the transfer blurring of a toner image. According to the first embodiment, the press force caused by the press pad 50 is smaller than the press force caused by the belt pressing roller 52. As the impact on the front end of the sheet P entering the inlet position 50b of the press pad 50 is weaker, the front end of the sheet P will not a receive severe and sharp impact at the inlet position 50b of the press pad 50 during conveyance, and, consequentially, the vibration of the sheet P is smaller.

### Second Embodiment

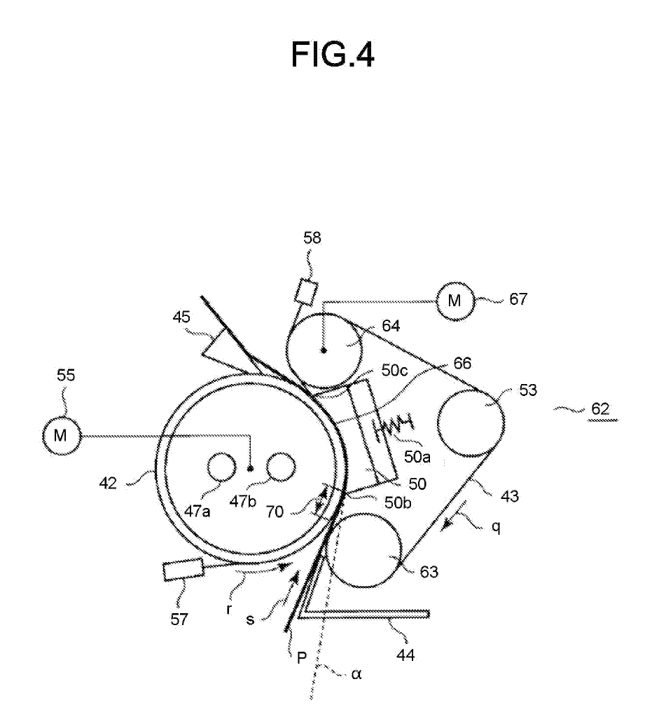

The image forming apparatus according to a second embodiment is described below with reference to FIG. 4. The difference between the second embodiment and the first embodiment lies in the configuration of a fixing apparatus. The configuration of the second embodiment that is the same as that described in the first embodiment is denoted with the same reference numeral and is therefore not described here in detail.

As shown in FIG. 4, a fixing apparatus 62 according to the second embodiment comprises a first stretch roller 63 as an inlet guide and a second stretch roller 64 as an outlet guide. A press belt 43 is stretched by the first stretch roller 63, the second stretch roller 64, and the tension roller 53. In the fixing apparatus 62, a motor 67 drives the second stretch roller 64 to rotate the press belt 43 in a direction indicated by an arrow q. Spaced by the press belt 43, the first stretch roller 63 and the second stretch roller 64 are not in contact with the heat roller 42.

The press belt 43 is supported by the first stretch roller 63 and the second stretch roller 64 in an area opposite to the heat roller 42 and is in contact with the heat roller 42 by being wound on the heat roller 42, and a nip 66 is formed between the heat roller 42 and the press belt 43 around the position of a press pad 50. There is no limit on the size of the press pad 50. As the second stretch roller 64 does not press the press belt 43 towards the direction of the heat roller 42 and press pad 50 is mainly used to form the nip 66, the width of the press pad 50 in the rotation direction of the press belt 43 can be increased to increase the length of the nip 66 so that an expected fixation performance can be achieved.

The first stretch roller 63 is located at a position closer to the heat roller 42 than the tangent α of the heat roller 42 at the inlet position 50b of the press pad 50. The first stretch roller 63 located close to the heat roller 42 forms a nip guide portion (second nip) 70 upstream with respect to the inlet position 50b of the press pad 50, at which the press belt 43 is wound on the heat roller 42. Further, the first stretch roller 63 or the second stretch roller 64 maybe in contact with the heat roller 42 with the press belt 43 therebetween.

In a printing process of the fixing apparatus 62, a sheet P reaching the nip guide portion 70 is clamped between the heat roller 42 rotating along the direction indicated by an arrow r and the press belt 43 rotating along the direction indicated by the arrow q and guided to the inlet position 50b of the press pad 50. The sheet P guided to the inlet position 50b of the press pad 50 from the nip guide portion 70 enters a part of the nip 66 formed between the heat roller 42 and the press belt 43 by the press pad 50. By passing through the nip 66, the color toner images formed on the sheet P are fixed onto the sheet P by being heated and pressurized onto the sheet. The sheet P coming out from the nip 66 is peeled from the heat roller 42 by a peeling claw 45 and discharged to a paper discharging section 12 by a paper discharging roller pair 33.

When passing through the fixing apparatus 62, a sheet P is first clamped in the nip guide portion 70 without receiving an impact and conveyed towards the inlet position 50b of the press pad 50. Then, there is an impact on the front end of the sheet P at a moment when the sheet P enters the nip 66 from the inlet position 50b of the press pad 50. However, as the sheet P is clamped in the nip guide portion 70, the impact on the front end of the sheet P is absorbed in the nip guide portion 70 and not transferred to the rear part of the sheet P, a region of the sheet P located at the position of the secondary transfer roller 31 does not vibrate. Therefore, when the sheet P enters the inlet position 50b of the press pad 50, the region of the sheet P at the position of a secondary transfer roller 31 can be prevented from vibrating even if there is an impact on the front end of the sheet P. Thus, no transfer blurring of a toner image occurs. The result of the evaluation on the occurrence of the transfer blurring caused by an impact on a sheet during the fixation process of the fixing apparatus 62 was substantially the same as that obtained in the first embodiment.

According to the second embodiment, a nip guide portion 70 is formed at a position upstream with respect to the inlet position 50b of the press pad 50 of the fixing apparatus 62. When a sheet P enters the inlet position 50b of the press pad 50, the nip guide portion 70 absorbs the vibration of the sheet P even if there is an impact on the front end of the sheet P. Like in the first embodiment, the sheet P at the position of the secondary transfer roller 31 is prevented from vibrating whether or not there is an impact on the sheet P entering the nip 66, thereby preventing a blurred image transfer.

In the embodiments described above, it is set that the endless heating section is in a roller shape and the endless press section is in a belt shape, however, it may also be set that the heating section is in a belt shape and the press section is in a roller shape. For example, a belt-shaped heating section may be wound on a roller-shaped press section to form a guide section.

According to at least one of the embodiments described above, a guide section is formed at a position upstream with respect to the inlet of a nip to absorb the vibration of a recording medium entering the nip. By preventing the vibration of the recording medium entering the nip at a transfer position, the transfer blurring of an image is prevented.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A fixing apparatus, comprising:
a rotating unit;
a pressing unit;
an urging unit configured to urge a portion of the pressing unit towards the rotating unit to form a first nip between the rotating unit and the urged portion of the pressing unit; and
a supporting unit disposed upstream of a conveying direction of a sheet with respect to the urging unit to form a second nip between the rotating unit and a portion of the pressing unit.

2. The fixing apparatus according to claim 1, wherein one continuous nip is formed by the first nip and the second nip.

3. The fixing apparatus according to claim 1, wherein the second nip is downstream of the conveying direction with respect to a portion of the pressing unit that contacts the support unit.

4. The fixing apparatus according to claim 1, wherein a pressure at the first nip is greater than a pressure at the second nip.

5. The fixing apparatus according to claim 1, wherein the supporting unit is a first supporting unit, and further comprising:
a second supporting unit disposed downstream of the conveying direction with respect to the urging unit to form a third nip between the rotating unit and a portion of the pressing unit.

6. The fixing apparatus according to claim 5, wherein a pressure at the third nip is greater than a pressure at the first nip.

7. The fixing apparatus according to claim 6, wherein the pressure at the first nip is greater than a pressure at the second nip.

8. The fixing apparatus according to claim 5, wherein the third nip is formed between the rotating unit and a portion of the pressing unit that contacts the second supporting unit.

9. The fixing apparatus according to claim 1, further comprising:
a heating unit configured to generate heat and disposed in the supporting unit.

10. An image forming apparatus comprising:
an image forming unit configured to form an image on a medium; and
a fixing apparatus configured to fix the image onto the medium, the fixing apparatus including,
a rotating unit,
a pressing unit,
an urging unit configured to urge a portion of the pressing unit towards the rotating unit to form a first nip between the rotating unit and the urged portion of the pressing unit, and
a supporting unit disposed upstream of a conveying direction of a sheet with respect to the urging unit to form a second nip between the rotating unit and a portion of the pressing unit.

11. The image forming apparatus according to claim 10, wherein one continuous nip is formed by the first nip and the second nip.

12. The image forming apparatus according to claim 10, wherein the second nip is downstream of the conveying direction with respect to a portion of the pressing unit that contacts the supporting unit.

13. The image forming apparatus according to claim 10, wherein a pressure at the first nip is greater than a pressure at the second nip.

14. The image forming apparatus according to claim 10, wherein the supporting unit is a first supporting unit, and the fixing apparatus further includes a second supporting unit disposed downstream of the conveying direction with respect to the urging unit to form a third nip between the rotating unit and a portion of the pressing unit.

15. The image forming apparatus according to claim 14, wherein a pressure at the third nip is greater than a pressure at the first nip.

16. The image forming apparatus according to claim 15, wherein the pressure at the first nip is greater than a pressure at the second nip.

17. The image forming apparatus according to claim 14, wherein the third nip is formed between the rotating unit and a portion of the pressing unit that contacts the second supporting unit.

18. The image forming apparatus according to claim 10, wherein the fixing apparatus further includes a heating unit configured to generate heat and disposed in the supporting unit.
